(19) United States
(12) Patent Application Publication
(10) Pub. No.: US 2003/0235499 A1
(43) Pub. Date: Dec. 25, 2003

(54) Multi focus hemi-spherical elastic bearing

(76) Inventor: David N. Schmaling, Southbury, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/178,479

(22) Filed: Jun. 24, 2002

(51) Int. Cl. B64C 27/35

(52) U.S. Cl. 416/134 A; 416/140

(57) ABSTRACT

A multi-focus elastomeric bearing system provides a plurality of hemi-spherical bearings arranged in series. An inner hemi-spherical bearing rotates about a focal point which is X distance above a pitch change axis while an outer hemi-spherical bearing rotates about a focal point which is X distance below the pitch change axis. The bearing system thus has an effective rotational center along the pitch change axis. The inner hemi-spherical bearing has a greatly reduced radius and high wrap-around angle, while the outer hemi-spherical bearing has an increased radius and reduced wraparound which provides a more requirement tailored bearing system.

### BACKGROUND OF THE INVENTION

The elastomeric bearing system of the present invention relates to an elastomeric bearing system, and more particularly to a multi-focus hemi-spherical elastic bearing having a series of hemi-spherical bearings each rotating about a different focal point.

Bearingless or “flexbeam” rotor systems require resilient load carrying members between the flexbeam and its surrounding torque tube. The load carrying members position the flexbeam and the attached rotor blade spar for pitch change, flapping and lead/lag motion about the intersection of the pitch change and flapping axes.

The load carrying members are typically elastomeric bearings known as snubber/dampers which include vertically stacked arrangements of elastomeric laminates to center the torque tube about the flexbeam while allowing flapping, pitch and lead/lag motions. Spherical bearings or “snubbers” accommodate pitch change and flapping rotation (as well as a small amount of lead/lag rotation) while flat layers accommodate lead/lag linear motions and some radial (spanwise) motion.

The snubber/dampers are located between the flexbeam spar and the torque tube under a preload so that the elastomer laminates thereof remain in compression throughout the full range of articulation as the elastomeric laminates may fail under tension. The snubber/dampers are commonly mounted through a clearance opening in the torque tube and attached through an opening in the flexbeam spar. The snubber/dampers are axially preloaded by a shimming procedure. Preloading reduces the free height of the elastomeric stack while pre-stressing the torque tube. Although highly effective, difficulties arise with conventional bearingless rotor systems.

As the blade lead/lags, the preload leads/lags which generates high bending load moments. The bending load moments may overcome the compressive preload and produce tension in the elastomeric bearing arrangement. Tension is detrimental to elastomeric laminates as tension operates to delaminate the elastomeric bearing arrangement. As lead/lag motion increases, the preload is further reduced which thereby further compounds this effect.

Consideration must also be provided for the size of the elastomeric bearing in relation to the accommodation of loads and motions involved in flight as designs which meet desired flight envelope capabilities may not be readily contained within the torque tube. Simply increasing the torque tube size would undesirably increase rotor system weight and drag.

Accordingly, it is desirable to provide a bearingless rotor system which overcomes these difficulties while improving the fatigue life of the elastomeric snubber/damper bearing.

### SUMMARY OF THE INVENTION

The multi-focus elastomeric bearing system according to the present invention provides a plurality of hemi-spherical bearing elements arranged in series. The hemi-spherical bearing elements each rotate about a respective focal point.

Snubber bearings allow a bearingless rotor torque tube to pitch, flap, and lead/lag rotate about a fixed point on a flexbeam. Such a snubber is often used in conjunction with a lead/lag damper, and they provide a reaction path to the flexbeam for pitch link forces, rotor flap shears, and damper forces. The pitch motions for a main rotor application are typically 10+/−20 degrees; flap motions are typically 4+/−8 degrees, and lead/lag motions 1+/−3 degrees.

For the outermost hemi-spherical bearing elements, pitch link load, flap shear load, and snubber preload act normal to the elastomer surface (i.e. axial load), and the damper load acts perpendicular to this normal (i.e. radial load). As the bearing rotates, these forces rotate as well, maintaining their direction of action on the outer rubber layer. The outer hemi-spherical bearing element experiences these loads and it is necessary that the compression-induced shear stress due to the axial component of load exceeds the tension-induced shear stress due to the radial component of the load. For a given layer radius, this requirement defines the minimum wrap-around angle required to ensure that the elastomer layer does not go into tension.

For the relatively fixed inner hemi-spherical bearing elements, the pitch link load, flap shear load, snubber preload, and damper load rotate with the bearing outer race, changing the direction of action of these forces, producing a much higher component of radial load relative to axial load. This requires that the inner hemi-spherical bearing elements have a larger wrap-around angle to carry the radial load without the tension induced shear stress due to the radial load overcoming the compression induced shear stress due to the axial load. It is also advantageous for the inner hemi-spherical bearing elements to have a minimum radius.

In one bearing system according to the present invention, the inner hemi-spherical bearing rotates about a focal point which is X distance above a pitch change axis while the outer hemi-spherical bearing rotates about a focal point which is X distance below the pitch change axis. Because both bearings have the same stiffness, each bearing will rotate the same amount and in series. The bearing system thus has an effective rotational center along the pitch change axis. The inner hemi-spherical bearing has a greatly reduced radius and high wrap-around angle, while the outer hemi-spherical bearing has an increased radius and reduced wraparound which provides a more effectively tailored bearing system.

In one bearing system according to the present invention, a third hemi-spherical bearing is provided in series between the inner and outer hemi-spherical bearing. This bearing system provides a more gradual transition between the inner and outer hemi-spherical bearings and also provides the transition from small radius/large wraparound to larger radius/reduced wraparound that is consistent with the loads that are typically applied to a hemi-spherical bearing.

The present invention therefore overcomes difficulties associated with conventional elastomeric bearings while providing an increase in the elastomeric bearing fatigue life.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view a flexbeam rotor system having a elastomeric bearing system according to the present invention;

FIG. 2 is a side view of the flexbeam rotor system;

FIG. 3 is a is a sectional view of the rotor blade of FIG. 2 taken along the line 3-3;

FIG. 4 is a general perspective view of the elastomeric bearing system;

FIG. 5 is a schematic view of the elastomeric bearing system illustrating an articulated position;

FIG. 6 is a schematic view comparing elastomeric bearing system radius relative to a focal point location;

FIG. 7 is a sectional view of a multi-focus elastomeric bearing system according to the present invention; and

FIG. 8 is a sectional view of another multi-focus elastomeric bearing system according to the present invention; and

### DETAILED DESCRIPTION OF THE PREFERRED EMBODIMENT

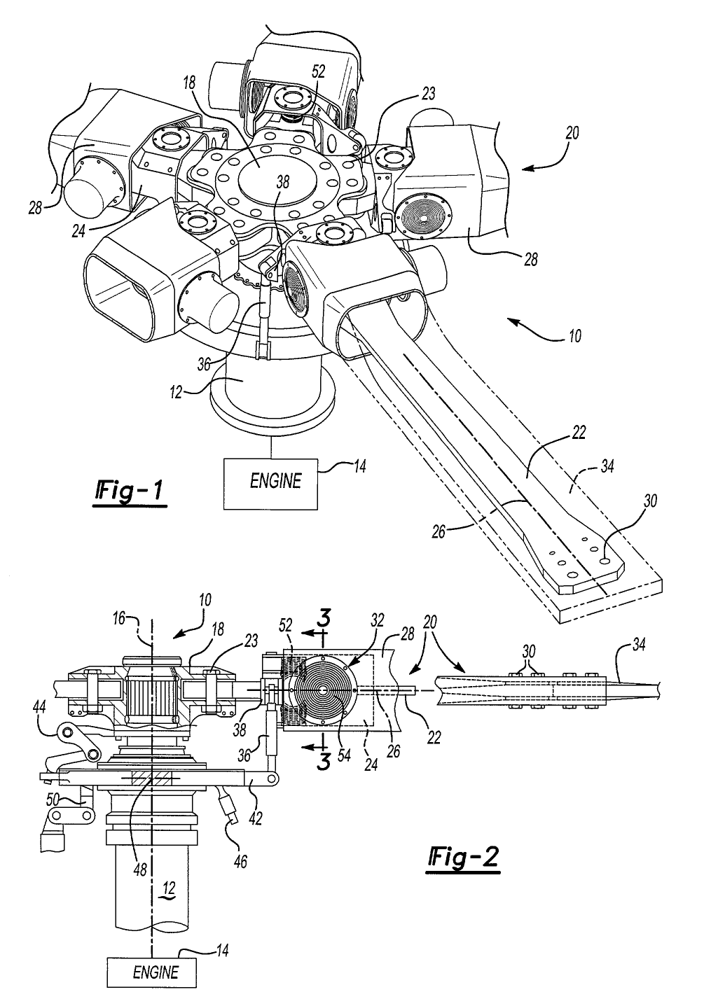

FIG. 1 illustrates a general perspective view of a flexbeam rotor system 10 which includes a drive shaft 12 which is driven in conventional fashion by an engine 14, typically through reduction gearing (not shown), for rotation about an axis of rotation 16 (FIG. 2). A rotor hub 18 is mounted on the drive shaft 12 for rotation therewith about axis 16 and supports therefrom a series of blade assemblies 20. It should be understood that although a particular rotor system 10 is illustrated in the disclosed embodiment, other main and tail rotor systems will benefit from the present invention.

Each blade assembly 20 includes a flexbeam 22 integrally connected to the rotor hub 18 by fasteners 23 (FIG. 2) so as to be flexible about a pitch change axis 26. Other attachment devices and methods will also benefit from the present invention. An intermediate tube 24 and a torque tube 28 envelopes flexbeam 22 in spaced relation thereto. The torque tube 28 is connected to the flexbeam 22 at its radially outer end by connecting fasteners 30 and is articulately connected thereto through the intermediate tube 24 and snubber-vibration damper system 32. Torque tube 28 is connected or preferably integral with an aerodynamic rotor blade member 34. It should be understood that although the description will make reference to but a single blade assembly 20, such description is applicable to each blade assembly 20.

Referring to FIG. 2, pitch change loads are imparted to each blade assembly 20 by pitch control rods 36 which are articulatably connected at one end to the outer periphery of the intermediate tube 24 at a pitch horn 38. The opposite end of the pitch control rod 36 is articulately connected to a swashplate 42. The swashplate 42 is connected by a scissors arrangement 44 to the rotor hub 18 for rotation therewith. The swashplate 42 receives control inputs from control rods 46, 50.

Pitch control commands imparted by swashplate control rods 46 cause tilting of swashplate 42 about point 48. Tilting of the swashplate 42 imparts pitch change loads to the intermediate tube 24 through pitch control rod 36. Pitch change loads to the intermediate tube 24 are imparted to the torque tube 28 and flexbeam 22 through the snubber-vibration damper system 32. Interaction of the snubber-vibration damper system 32 with the torque tube 28 causes the torque tube 28, flexbeam 22 and blade member 34 to pitch about pitch change axis 26. Inputs from control rods 50 cause the swashplate 42 to axially translate along axis of rotation 16 to impart pitch control loads to the intermediate tube 28 and, hence, blade member 34. When swashplate 42 translates along axis 16, it imparts collective pitch change to blade assemblies 20, and when it tilts about point 48, it imparts cyclic pitch change.

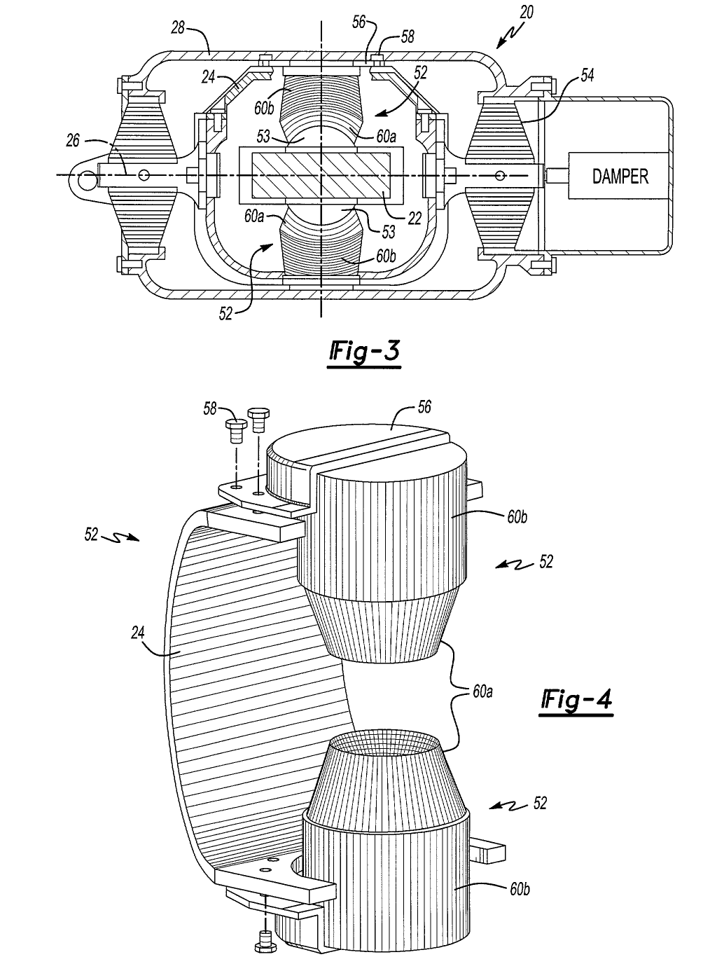

Referring to FIG. 3, each blade assembly 20 includes a multi-focus elastomeric bearing system 52 within the intermediate tube 24 and/or a torque tube 28. The elastomeric bearing system 52 is located between the flexbeam 22 and the intermediate tube 24 and/or the torque tube 28. Each elastomeric bearing system 52 is mounted to the flexbeam 22 through a fixed inner race 53. Inner race 53 is preferably a rigid hemi-spherical member attached directly to the flexbeam 22. A snubber bearing is often used in conjunction with a lead/lag damper 54 to provide a reaction path (to the flexbeam) for pitch link forces, rotor flap shears, and damper forces.

It should be understood that various bearingless rotor systems as well as other elastomeric pivots will benefit from the present invention. Preferably, a removable preload cap 56 attached to the intermediate tube 24 through fasteners 58 or the like to provides access and preload to the elastomeric bearing system 52 (also illustrated in FIG. 4).

The elastomeric bearing system 52 includes a plurality of hemi-spherical bearing elements 60a, 60b and cylindrical bearing elements 62. The cylindrical bearing elements 62 are axisymmetric shells defined about the pitch change axis 26 to accommodate some of the pitch motion and all of the spanwise linear motion. Although described with regard to hemi-spherical elastomeric bearings such as articulated rotor retention and bearingless rotor snubber bearings i.e., those requiring externally applied precompression, other elastomeric bearings such as pitch link, damper rod ends, hemi-spherical shell type bearings and other elastomeric pivots will also benefit from the present invention.

The elastomeric bearing system 52 allows a bearingless rotor torque tube to pitch, flap, and lead/lag rotate about a fixed point along the pitch change axis 26 of the flexbeam 22. The pitch change axis 26 is herein illustrated as the center of the flexbeam 22, however, the present invention should not be so limited. That is, the elastomeric bearing system 52 may define a focal point which is at neither the center of the flex beam nor along the pitch change axis 26.

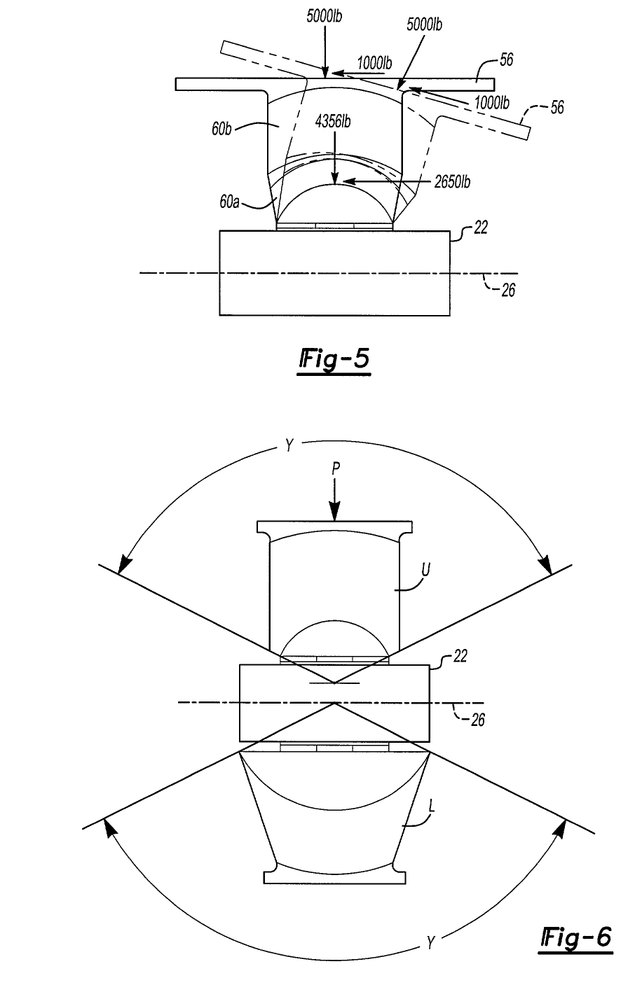

Referring to FIG. 5, for the outer hemi-spherical bearing elements 60b, pitch link load, flap shear load, and preload act normal to the elastomer surface (i.e. axial load), and the damper load acts perpendicular to this normal (i.e. radial load). As the bearing rotates, these forces rotate as well, maintaining their direction of action on the outer rubber layer. For example only, bearing position A schematically illustrates the elastomeric bearing system 52 with a preload of 5000 lb axial load and a 1000 lb radial load. The outermost layer of the outer hemi-spherical bearing element 60b experiences these loads (regardless of motion). It is important that the compression-induced shear stress due to the axial component of load exceeds the tension-induced shear stress due to the radial component of the load. For a given layer radius, this requirement defines the minimum wrap-around angle required to ensure that the elastomer layer does not go into tension.

For the relatively fixed inner hemi-spherical bearing elements 60a, the pitch link load, flap shear load, snubber preload, and damper load rotate with the bearing outer race, changing the direction of action of these forces, producing a much higher component of radial load relative to axial load. As illustrated by position B (in phantom), for a 20 degree pitch angle, the 5000 lb axial load and 1000 lb radial load will load the innermost layer of the inner hemi-spherical bearing element 60a with 4,356 lb axial load and 2,650 lb radial load. This requires that the inner hemi-spherical bearing elements 60a have a larger wrap-around angle to carry the radial load without the tension induced shear stress due to the radial load overcoming the compression induced shear stress due to the axial load.

It is also advantageous for the inner hemi-spherical bearing elements 60a to have a minimum radius, because the motion induced shear stress is related to rθ/t where t defines the required thickness of the elastomer. As the flexbeam geometry is typically fixed, it is often necessary to increase r to achieve the required wrap-around angle. This may result in a relatively large bearing which is impractical for certain applications.

FIG. 6 illustrates two bearings with the same wrap-around angle, i.e. Y degrees. For a flexbeam that is 2 inches thick, the bearing L requires a radius of 2.78 inches to achieve a wraparound which locates the bearing focal point at the center of the flexbeam. If the focal point is located 0.5 inches above the center of the flexbeam, however, bearing U provides the same wrap-around with a bearing of radius 1.60 inch. Motion induced strain is less for the 1.6 inch radius bearing while the compression induced shear stress is greater. However, compression induced shear stress is readily compensated for by reducing the thickness of the shear deformable elastomeric material layers.

Referring to FIG. 7, the elastomeric bearing system 52 includes hemi-spherical bearing 60a, 60b arranged in series. The hemi-spherical bearing elements 60a, 60b each of which rotate about a respective focal point 66a, 66b. Preferably, the hemi-spherical bearing elements 60a, 60b are tailored in stiffness to insure smooth operation without binding or fore-shortening.

Each bearing 60a, 60b includes a plurality of layers of shear deformable elastomeric material layers 68 separated by shim layers 70 formed of high-stiffness constraining material such as composite or metallic layers. It should be understood, however, that various materials of differing rigidity will also benefit from the present invention. Relatively rigid transitional members 72 may additionally be located between hemi-spherical bearings 60a, 60b.

The hemi-spherical bearings 60a, 60b are preferably of equal rotational stiffness. Hemi-spherical bearing 60a rotates about its focal point 66a which is X distance above the pitch change axis 26, and hemi-spherical bearing 60b rotates about its focal point 66b which is X distance below the pitch change axis 26. Because both bearings 60a, 60b have the same stiffness, each bearing will rotate the same amount and in series. The bearing system 52 thus has an effective rotational center along the pitch change axis 26. Hemi-spherical bearing 60a has a greatly reduced radius and high wrap-around angle, while hemi-spherical bearing 60b has an increased radius and reduced wrap-around angle. The radial component of load is less significant as the bearing extends away from the flexbeam 22.

Preferably, any number of bearings may be utilized in the series so long as the following relationships are maintained. A total bearing system stiffness is defined by the relationship:

Kbrg=1/(1/k1+1/k2+1/k3+ . . . 1/kn)

where

k1, k2, k3 . . . kn is the rotational stiffness of each hemi-spherical elastomeric bearing;

and the motion of each said hemi-spherical elastomeric bearings is defined by the relationship:

θn=(θ*Kbrg)/kn

where

θ is the total motion of the series of said hemi-spherical elastomeric bearings.

Preferably, the total motion of each bearing sums to zero to prevent binding and ensure smooth operation of the bearing system. That is, the bearing system 52 is defined by the relationship:

θ1*e1+θ2*e2+θ3*e3+ . . . θn*en=0.

where

e1, e2, e3, . . . en defines the individual focal point offsets of each hemi-spherical elastomeric bearing relative to a desired center of rotation.

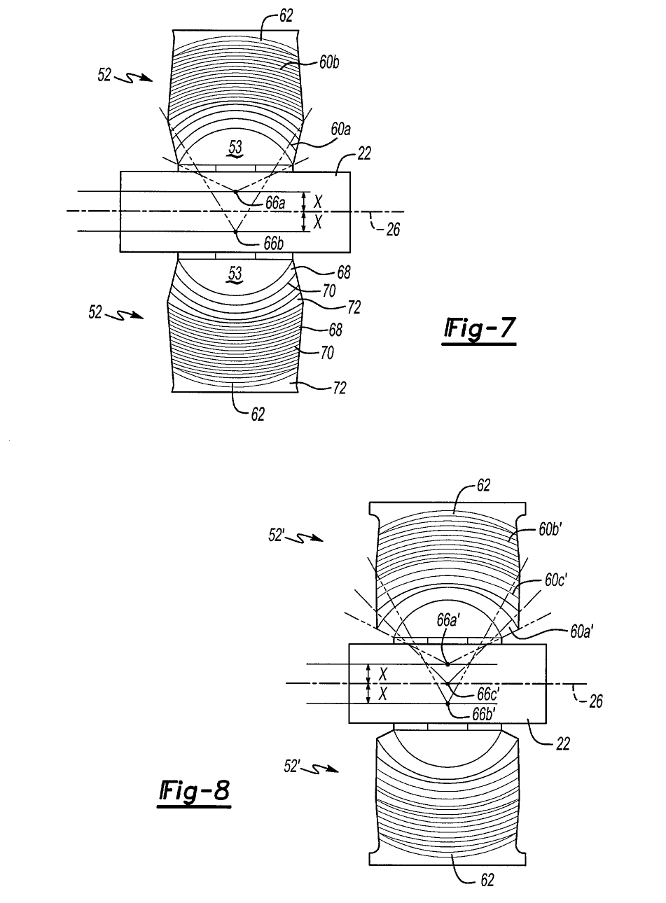

Referring to FIG. 8, another bearing system 52′ is illustrated. Bearing system 52′ includes three hemi-spherical bearings 60a′, 60b′, and 60c′. Hemi-spherical bearing 60a′ rotates about its focal point 66a′ which is X distance above the pitch change axis 26, and hemi-spherical bearing 60b′ rotates about its focal point 66b′ which is X distance below the pitch change axis 26. Hemi-spherical bearing 60c′ rotates about its focal point 66c′ which is located along the pitch change axis 26. Bearing system 52′ also has an effective rotational center along the pitch change axis 26. Bearing system 52′ provides a more gradual transition between the hemi-spherical bearings and also provides the transition from small radius/large wraparound to larger radius/reduced wraparound that is consistent with the loads that are typically applied to a hemispherical bearing.

It is typically advantageous to match the stiffness of the individual hemi-spherical bearings, however, this need not always be required. Matching the stiffness of a small radius bearing and a large radius bearing is preferably achieved by increasing the wraparound of the smaller radius bearing and reducing the wraparound of the large radius bearing. Additional bearing matching is achieved by tailoring the shear modulus, number of rubber layers, and thickness of the layers as generally known to one skilled in the art of elastomeric bearings in combination with the disclosure of the present invention.

The present invention provides structural benefits without compromising the bearing life and also allows separate pre-compression of the snubber as required. The present invention also increases snubber/damper life by assuring that the bearings always operate in compression.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An elastomeric bearing system comprising:
a first hemi-spherical elastomeric bearing which defines a first focus point; and
a second hemi-spherical elastomeric bearing mounted to said first hemi-spherical elastomeric bearing, said second hemi-spherical elastomeric bearing defining a second focus point different from said first focus point.

2. The elastomeric bearing system as recited in claim 1, wherein a total bearing system stiffness is defined by the relationship:
Kbrg=1(1/k1+1/k2+1/k3+ . . . 1/kn)
where
k1, k2, k3 . . . kn is a stiffness of each hemi-spherical elastomeric bearing.

3. The elastomeric bearing system as recited in claim 2, wherein a motion of each of said hemi-spherical elastomeric bearings is defined by the relationship:
θn=(θ*Kbrg)/kn
where
θ is the total motion of the series of said hemi-spherical elastomeric bearings.

4. The elastomeric bearing system as recited in claim 3, wherein said elastomeric bearing system is defined by the relationship:
θ1*e1+θ2*e2+θ3*e3+ . . . θn*en=0
where
e1, e2, e3, . . . en defines the individual focal point offsets of each hemi-spherical elastomeric bearing relative to a desired center of rotation.

5. The elastomeric bearing system as recited in claim 1, wherein a first stiffness of said first hemi-spherical elastomeric bearing is matched to a second stiffness of said second hemi-spherical elastomeric.

6 The elastomeric bearing system as recited in claim 1, wherein said first hemi-spherical elastomeric bearing comprises a first wraparound, and said second hemi-spherical elastomeric bearing comprises a second wraparound, said first wraparound greater than said second wraparound.

7. The elastomeric bearing system as recited in claim 1, wherein said first focus point is defined above a pitch change axis of a flex beam and said second focus point is defined below said pitch change axis.

8. The elastomeric bearing system as recited in claim 1, further comprising a third hemi-spherical elastomeric bearing which defines a third focus point.

9. The elastomeric bearing system as recited in claim 8, wherein said first focus point is defined above a pitch change axis of a flex beam, said second focus point is defined below said pitch change axis and said third focus point is defined upon said pitch change axis.

10. A rotor blade assembly comprising:
a flexbeam defining a pitch change axis;
an elastomeric bearing system mounted to said flexbeam, said elastomeric bearing system comprising
a first hemi-spherical elastomeric bearing which defines a first focus point above said pitch change axis; and
a second hemi-spherical elastomeric bearing mounted to said first hemi-spherical elastomeric bearing, said second hemi-spherical elastomeric bearing defining a second focus point below said pitch change axis.

11. The rotor blade as recited in claim 10, further comprising a third hemi-spherical elastomeric bearing which defines a third focus point along said pitch change axis.

12. The rotor blade as recited in claim 10, wherein said elastomeric bearing system comprises a plurality of hemi-spherical bearing elements and a plurality of cylindrical bearing elements mounted in series.

13. The rotor blade as recited in claim 10, wherein a first stiffness of said first hemi-spherical elastomeric bearing is matched to a second stiffness of said second hemi-spherical elastomeric.

14. The rotor blade as recited in claim 10, wherein said first hemi-spherical elastomeric bearing comprises a first wraparound angle, and said second hemi-spherical elastomeric bearing comprises a second wraparound angle, said first wraparound angle greater than said second wraparound angle.

15. The rotor blade as recited in claim 14, wherein said first hemi-spherical elastomeric bearing is mounted to said flexbeam and said second hemi-spherical elastomeric bearing.

16. The rotor blade as recited in claim 15, wherein said first hemi-spherical elastomeric bearing is mounted to said flexbeam through a rigid hemi-spherical inner race.

17. The rotor blade as recited in claim 15, wherein a total stiffness of said elastomeric bearing system is defined by the relationship:
Kbrg=1/(1/k1+1/k2+1/k3+ . . . 1/kn)
where
k1, k2, k3 . . . kn is a stiffless of each hemi-spherical elastomeric bearing.

18. The rotor blade as recited in claim 17, wherein a motion of each of said hemi-spherical elastomeric bearings of said elastomeric bearing system is defined by the relationship:
θn=(θ*Kbrg)/kn
where
θ is the total motion of the series of said hemi-spherical elastomeric bearings.

19. The rotor blade as recited in claim 18, wherein said elastomeric bearing system is defined by the relationship:
θ1*e1+θ2*e2+θ3*e3+ . . . θn*en=0
where
e1, e2, e3, . . . en defines the individual focal point offsets of each hemi-spherical elastomeric bearing relative to a desired center of rotation.
